(19) United States
(12) Patent Application Publication
(10) Pub. No.: US 2021/0101803 A1
(43) Pub. Date: Apr. 8, 2021

(54) PORTABLE FLUID COLLECTION AND FILTRATION SYSTEM

(71) Applicant: Kärcher North America, Inc., Denver, CO (US)

(72) Inventors: Bruce Allen Hurtado, Vancouver, WA (US); Gerardo Angel Gonzalez-Chapa, Camas, WA (US); Trent Garner, Highlands Ranch, CO (US); Kyle Murray, Vancouver, WA (US)

(73) Assignee: Kärcher North America, Inc., Denver, CO (US)

(21) Appl. No.: 17/061,847

(22) Filed: Oct. 2, 2020

Related U.S. Application Data
(60) Provisional application No. 62/909,888, filed on Oct. 3, 2019.

(51) Int. Cl. C02F 1/00; B01D 29/05; B01D 29/56; B01D 35/027

(52) U.S. Cl. CPC C02F 1/002; B01D 35/027; B01D 29/56; B01D 29/05

(57) ABSTRACT

Fluid treatment and recycling systems are provided. In various embodiments, systems are provided that are portable or semi-portable such that the systems can be conveyed to various locations or work sites. Systems are provided with a plurality of filtration elements or stages. Systems of the present disclosure are operable to remove coarse and fine particulates from a quantity of fluid such that the fluid is rendered suitable for further use.

This U.S. Non-Provisional Patent Application claims the benefit of priority from U.S. Provisional Patent Application Ser. No. 62/909,888, filed Oct. 3, 2019, the entire disclosure of which is hereby incorporated by reference.

### FIELD

The present disclosure relates generally to fluid collection and filtration systems. More specifically, embodiments of the present disclosure relate to portable fluid collection and recycling systems. In some embodiments, devices are provided that comprise pumping, filtration, oil removal, and solids disposal capabilities.

### BACKGROUND

Various wastewater treatment technologies and devices are known. Certain wastewater treatment and recycling devices are provided as portable or on-site systems as opposed to large-scale industrial or municipal permanent installations (for example). Of the various known portable or semi-portable wastewater treatment devices, certain devices are provided that are useful for capturing, treating and reusing water or other fluid during various operations including, but not limited to, cleaning and pressure washing applications. However, known devices generally fail to provide a compact, easily portable device that comprises cleaning and filtration abilities of the present disclosure.

### SUMMARY

There has been a long-felt and unmet need to provide a fluid treatment and recycling device that is capable of filtering or cleaning fluid to a sufficient quality such that it may be introduced or reintroduced to high-pressure cleaning equipment, for example. There has further been a need to provide such a device that captures essentially all suspended solids in a quantity of fluid in disposable collection bags. There has also been a long-felt and unmet need to provide a system that prevents excessive sludge accumulation in the bottom of a collection tank and eliminates or reduces the need for manual purging.

In various embodiments, systems and devices are provided that recover wastewater produced by cleaning operations including, but not limited to mobile cleaning operations. Systems, devices and methods of the present disclosure comprise a multi-stage treatment process that removes particulate matter, oil, grease, and other contaminants. Treated water is rendered suitable for reuse in cleaning operations and other applications. Systems and devices of the present disclosure are operable to be provided for use with, connected to, and provided in communication with various different applications and processes, wash processes, cleaning equipment, storage tanks, and other ancillary equipment. However, in preferred embodiments, systems and devices of the present disclosure are operable for use with and well suited for use with mobile pressure washing applications.

It is an object of the present disclosure to provide a system that captures essentially all of the suspended solids in a quantity of fluid or wastewater. In some embodiments, solids are captured and retained in at least one removable and disposable collection bag or filter. In preferred embodiments, suspended solids and viscous liquids (e.g. oils) are removed from a quantity of water through the use of disposable filter bags.

Embodiments of the present disclosure provide a system comprising multiple-pass filtration of recycled water to provide sufficient quality and cleanliness such that the fluid can be introduced into a high-pressure pump or similar device (i.e. a positive-displacement piston or plunger type device). In preferred embodiments, fluid can be selectively and/or automatically segregated based on cleanliness. For example, fluid that is of sufficient cleanliness for use or re-use can be directed by the system to a water storage tank or directly to a pressure washer or similar device. Fluid that is not of sufficient purity or cleanliness is routed or directed by the system to further treatment processes. Further treatment processes include at least one of subjecting the fluid to a cartridge filter, a bag filter, and a hydrocyclone filter. In addition to routing or directing fluid within a system based on the cleanliness of the fluid, systems of the present disclosure are further operable to direct and manage fluid flow so as to provide a desired amount of fluid within certain features of the system. For example, in some embodiments, tanks of the present disclosure comprise one or more float valves that are operable to automatically initiate a fluid flow into or out of the tank based on a position of the float valve. Such embodiments provide for an adequate amount of fluid and hydrostatic pressure (for example) to be provided within the tank and to optimize system performance.

Embodiments of the present disclosure comprise systems that provide for extended run time between filter service or replacement compared with existing devices. In various embodiments, various features are provided to filter or separate large or course particulates without subjecting finer filtration systems to such particulates. For example, in some embodiments, a hydrocyclone filter is provided within the system to remove large debris (e.g. sand and larger debris) prior to such debris reaching a bag filter that is intended primarily for removing finer matter. Systems, methods and devices of the present disclosure provide for a fluid filtration and recycling system capable of removing small particulates from a supply of fluid. For example, in some embodiments, devices of the present disclosure filter debris and particulates as small as 5.0 microns or less. Removed solids, oils, and other contaminants are captured in at least one bag filter which comprises at least one removable and disposable bag filter.

Embodiments of the present disclosure also provide a collection tank, and comprise features and systems that prevent excessive sludge accumulation in a lower portion of the collection tank, and therefore eliminate or reduce the need to manually purge a tank. In some embodiments, tanks of the present disclosure are provided with a sloped bottom or sump portion. In various embodiments, at least one agitator is provided in or proximal to the bottom or sump portion. The at least one agitator comprises at least one of an agitator nozzle and a propeller-type agitator.

Embodiments of the present disclosure comprise various feedback devices including, but not limited to pressure gauges to allow for monitoring of various operating parameters, changes in performance, need to replace filters, etc. In some embodiments, devices of the present disclosure are provided with instrumentation and devices that comprise the ability to connect to and/or report back to a central processing unit.

In various embodiments, certain cleaning functions and device operations are automated. For example, in some embodiments, systems of the present disclosure comprise automated features for activating and deactivating vacuum operations and controlling a fill level of a tank. In some embodiments, the automated features comprise float valves to activate various features including, for example, water inlets, drains, and/or vacuum motors. In some embodiments, fluid level is controlled to optimize hydraulic performance, flow rates, pressures, and overall system performance.

In certain embodiments, various device functions are automated. In some embodiments, it is contemplated that a controller is provided that is operable to receive inputs from various portions of the system and provide outputs to control device functionality. For example, it is contemplated that a level sensor is provided that is in communication with a controller, and the controller is in communication with at least one of a pump and a valve to direct fluid to or away from a storage volume in which the level sensor is provided. It is also contemplated that the system and controller are provided with various auto-shut off features. For example, it is contemplated that a controller is provided that is operable to receive information and (for example) deactivate the pump when a predetermined pressure value in the system is exceeded. The predetermined pressure value may correspond to an unacceptably high pressure resulting from a clogged filter or obstruction in the system, for example.

In various embodiments, system features and components are provided on a relatively compact skid or assembly. In certain embodiments, various system features are provided within a molded plastic body portion. These features are contemplated are comprising features which generally do not experience significant heat build-up and do not require significant maintenance, are substantially hidden from view and protected from contact and impact. It is further contemplated that certain features and components of systems of the present disclosure are more exposed than others. For example, some embodiments provide for at least one pump that is not shrouded or surrounded by the body portion to facilitate cooling of the pump via convection. Although certain embodiments of the present disclosure contemplate a specific structure and arrangement (see FIGS. 1 and 2, for example), the present disclosure is not limited to any particular structure or arrangement of parts. It is contemplated, for example, that a molded body member extends around substantially all system components. It is also contemplated that certain embodiments expose significantly more of the internal components and working elements of the device than is shown in certain Figures.

In one embodiment, a portable fluid treatment and recycling system is provided that comprises a vacuum port, a fluid tank with a lower portion comprising a sump, a vacuum pump provided in communication with the fluid storage tank, and wherein the fluid tank comprises a first filter and a second filter. A pump is provided that is operable to receive fluid from the fluid tank. A third filter is provided that is operable to receive fluid from the pump and remove at least one of sand, silt, sediment, oil, and debris from the fluid. The third filter comprises a first outlet and a second outlet. The first outlet is provided in fluid communication with the second filter within the fluid tank, and the second outlet is provided in fluid communication with the lower portion of the fluid tank and with a fourth filter. A fourth filter is provided that comprises an outlet that is operable to be selectively connected to at least one of a fluid conduit, a storage tank, and a pressure washer.

In various embodiments, fluid treatment and recycling systems are provided that comprise a compact, lightweight, and portable arrangement. In certain embodiments, the size and weight of fluid systems of the present disclosure are reduced while maintaining capacity to process, treat, and move significant amounts of fluid. In other words, more compact and lightweight devices are provided without sacrificing performance. In certain embodiments, this is achieved by providing systems with thin sidewall construction for a vacuum tank. Devices of the present disclosure are contemplated as comprising ribbed sidewalls to enhance the structural integrity of the tank and withstand forces from a vacuum pump, impact, etc. while reducing the amount of material required to form the tank (for example). Reduced sidewall thickness provides for a lighter system and reduces manufacturing costs. Additionally, certain embodiments of the present disclosure provide frame and tank members comprising structural supports that resist forces including, but not limited to, cyclic loading forces applied by vacuum systems of the present disclosure. In some embodiments, a supporting rib extends from a frame to support loads applied to the tank. Additionally, it is contemplated that certain embodiments of the present disclosure comprise tanks with internal supports including but not limited to inserts and extensions of the tank to receive and supports various loads.

The above-described embodiments, objectives, and configurations are neither complete nor exhaustive. As will be appreciated, other embodiments of the invention are possible using, alone or in combination, one or more of the features set forth above or described in detail below.

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

### BRIEF DESCRIPTION OF THE DRAWINGS

The accompanying drawings, which are incorporated in and constitute a part of the specification, illustrate embodiments of the invention and together with the Summary given above and the Detailed Description of the drawings given below, serve to explain the principles of these embodiments. In certain instances, details that are not necessary for an understanding of the invention or that render other details difficult to perceive may have been omitted. It should be understood, of course, that the invention is not necessarily limited to the particular embodiments illustrated herein. Additionally, it should be understood that the drawings are not necessarily to scale.

FIG. 1 is a front perspective view of a fluid collection and filtration system according to one embodiment of the present disclosure.

FIG. 2 is a rear elevation view of the fluid collection and filtration system of the embodiment of FIG. 1.

FIG. 3 is a schematic of a fluid collection and filtration system according to one embodiment of the present disclosure.

FIG. 4 is a cross-sectional elevation view of a filter member according to one embodiment of the present disclosure.

FIG. 5 is a rear perspective view of a fluid collection and filtration system according to one embodiment of the present disclosure.

FIG. 6 is a cross-sectional plan view of a fluid collection and filtration system according to one embodiment of the present disclosure.

FIG. 7 is a cut-away perspective view of a fluid collection and filtration system according to one embodiment of the present disclosure.

Similar components and/or features may have the same reference label. Further, various components of the same type may be distinguished by following the reference label by a letter that distinguishes among the similar components. If only the first reference label is used, the description is applicable to any one of the similar components having the same first reference label irrespective of the second reference label.

### DETAILED DESCRIPTION

Embodiments of the present disclosure have significant benefits across a broad spectrum of endeavors. It is the Applicant's intent that this specification be accorded a breadth in keeping with the scope and spirit of the invention being disclosed despite what might appear to be limiting language imposed by the requirements of referring to the specific examples disclosed. To acquaint persons skilled in the pertinent arts most closely related to the present invention, a preferred embodiment that illustrates the best mode now contemplated for putting the invention into practice is described herein by, and with reference to, the annexed drawings that form a part of the specification. The exemplary embodiment is described in detail without attempting to describe all of the various forms and modifications in which the invention might be embodied. As such, the embodiments described herein are illustrative, and as will become apparent to those skilled in the arts, may be modified in numerous ways within the scope and spirit of the invention.

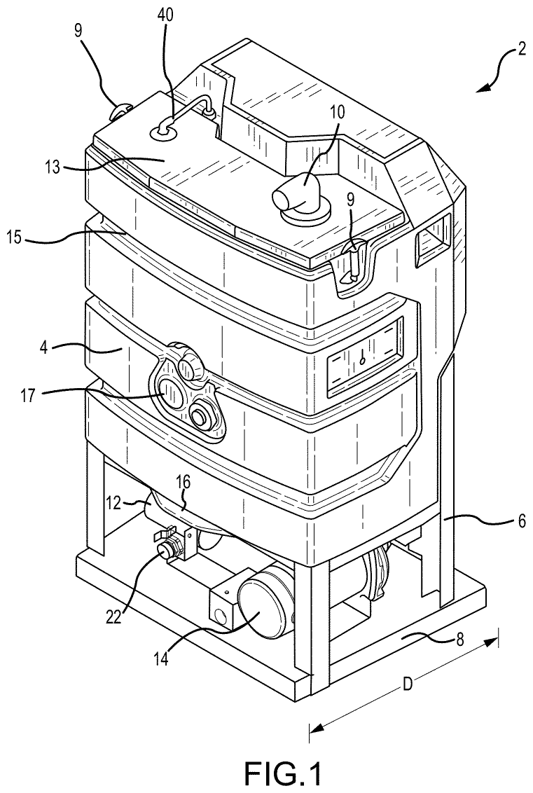

As shown in FIG. 1, a fluid collection and filtration system 2 is provided. The system 2 comprises a portable or semi-portable device that can be moved from one location or worksite to another with relative ease. The system 2 can be provided in or mounted to a truck bed or trailer, for example. It will be recognized, however, that no limitation with respect to the size or weight of the system 2 is provided. Indeed, it is specifically contemplated that systems and devices of the present disclosure can be scaled up or down in terms of size and weight to accommodate various different applications.

Various embodiments of the present disclosure, including that shown in FIG. 1, comprise concave ribs or depressions 15 to provide structural integrity to the body 4. In some embodiments, the depressions provide a receiving area for a reinforcing rib of the frame as will be shown and described herein. The structure of the body 4 and frame 6 provide for a reduced size of the system 2 without sacrificing performance. One or more ports 17 are provided on an external surface of the body 4 to allow two or more systems 2 to be connected in a series or parallel-type arrangement.

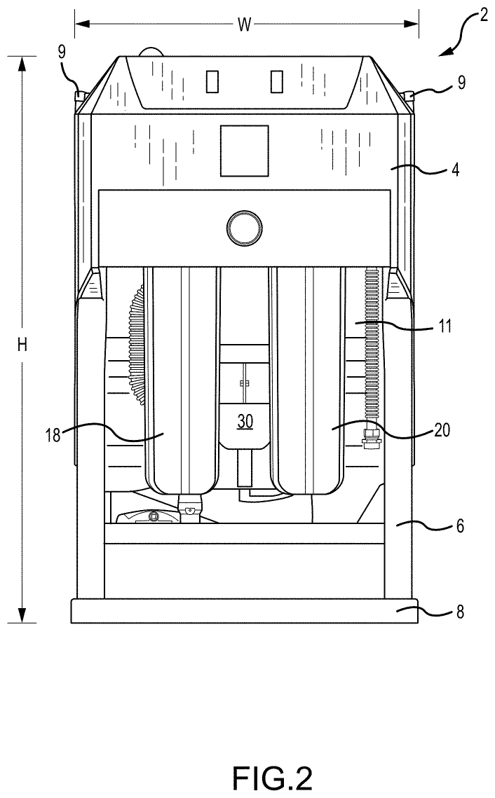

The system 2 of FIG. 1 comprises a molded body 4, a frame 6 and a base member 8. Various components are provided on or within the body 4, frame 6 and base member 8. For example, a filter 12 and a pump 14 are provided on the base member 8 and are in communication with additional system components as will be shown and described. The filter 12 is provided as a strainer to remove large solids from the fluid stream prior to the fluid entering the pump 14. The body 4 houses a tank having a sloped bottom or sump 16 that extends from the body 4 as shown in FIG. 1. An outlet is provided with a valve 22 at a lowest portion of the sloped bottom 16. The outlet preferably comprises a valve 22 that is operable to selectively expel fluids from the tank via a drain outlet, and to direct fluid to the pump 14 for recycling and processing. Although not shown in FIG. 1, the body 4 houses first and second filter bags. In preferred embodiments, a first bag is provided as a first pass filter for fluids and the first bag comprises a sand and debris bag filter with a porosity of approximately 200 microns. Fluid is passed through the first bag and allowed to be gravity fed to the outlet and valve 22 for further processing and filtration. As will be described in more detail herein, fluid is passed through the pump 14 and a sand separator 30 (FIG. 2) prior to being returned to the tank, passed through a cartridge filter, returned to a storage tank, reused for cleaning processes, and/or disposed of through an outlet in the system.

The molded body member 4 of FIG. 1 comprises a removable cover member 13 with clasps 9 or similar release members to allow for access to internal components of the system 2. For example, clasps 9 may be selectively opened or released to allow for removal of the cover member 13 and to allow a user to replace a bag filter (for example) that is provided within the system 2 or otherwise service or replace internal components of the system. An upper portion of the body member 4 also comprises a vacuum hose inlet 10 and a supply line 40, which are described in more detail herein.

In various embodiments, methods, devices and systems of the present disclosure contemplate and comprise the ability to connect a plurality of fluid collection and filtration systems. For example, it is contemplated that a plurality of systems 2 as shown in FIG. 1 are operable to be connected in series or in parallel. As shown in FIG. 1, the system 2 comprises at least one connection 17 on a portion of the tank 4. In preferred embodiments, systems 2 of the present disclosure comprise a fluid inlet and a fluid outlet on the exterior of the tank 4 to enable multiple systems 2 to be connected and provided in fluid communication with one another.

FIG. 2 is a rear elevation view of the system 2 of FIG. 1. As shown in FIG. 2, the system 2 comprises first and second cartridge filters 18, 20. Each of the cartridge filters 18, 20 are operable to receive fluid from the pump 12 and the sand separator 30. As shown in FIG. 2, the system 2 comprises a relatively compact and contained system. Components including, for example, a plurality of cartridge filters 18, 20, a sand separator 30, and fluid supply lines are provided adjacent to the tank 11. The system 2 comprises a relatively confined envelope having a frame 6 and a base member 8. In various embodiments, the system comprises a height H, width W and a depth D (see FIG. 1). In various embodiments, the height H of the system comprises a height of between approximately 20 inches and approximately 80 inches and more preferably of about 47 inches. In various embodiments, the width W of the system comprises a width of between approximately 12 inches and approximately 48 inches and more preferably of about 29 inches. In various embodiments, the depth D of the system comprises a depth of between approximately 10 inches and approximately 30 inches, and more preferably of about 21 inches.

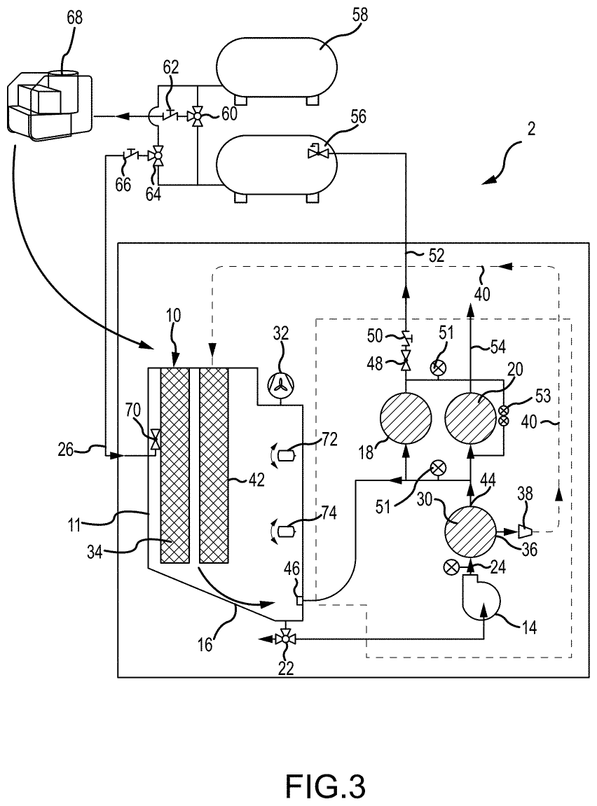

FIG. 3 is a schematic of a portable fluid and filtration system 2 according to one embodiment of the present disclosure. As shown in FIG. 3, the system 2 is provided in combination with related accessories including a clean water storage tank 58, a recycled water tank 56, and a pressure washing device 68. The system 2 preferably comprises a relatively compact and self-contained fluid processing and recycling system that can be selectively connected to various features including storage tanks and pressure washing devices as shown in FIG. 2, as well as municipal water supplies and various existing facilities and utilities as will be recognized by one of ordinary skill in the art. Accordingly, while embodiments of the present disclosure are particularly well-suited for use with pressure washing applications and recycling water associated therewith, systems, devices and methods of the disclosure are not limited to use with such operations.

As shown in FIG. 3, the system 2 comprises a primary inlet 10 for receiving a fluid. In preferred embodiments, the primary inlet 10 comprises a vacuum-hose inlet for providing a fluid to a tank 11 of the system 2. The tank 11 is preferably provided with a negative or vacuum pressure by the provision of a vacuum motor 32. The primary inlet 10 is connected to a first bag filter 34. In some embodiments, the first bag filter 34 comprises a sand and debris filter through which fluid is allowed to pass. The first bag filter 34 preferably comprises a porosity of between approximately 100 and 300 microns, and more preferably of about 190 to 210 microns. Fluid provided to the first bag filter 34 is gravity-fed through the filter 34 and allowed to drain to lower regions of the tank 11. The lower region of the tank 11 preferably comprises a sloped bottom 16 as shown. Although the sloped bottom of certain Figures is shown as an asymmetric sloped bottom, alternative arrangements are contemplated including, for example, various symmetric arrangements and sump features. A drain valve 22 is provided at an outlet of the tank 11. The drain valve 22 comprises a point of egress for fluid from the tank portion 11. In preferred embodiments, the drain valve 22 is selectively operated to drain fluid from the system and/or provide fluid to a pump 14 and additional system components for processing, recycling, and redirecting.

As shown in FIG. 3, a pump 14 is provided to convey fluid from an outlet of the tank 11 to a sand separator 30. The pump 14 is contemplated as comprising a centrifugal pump. Although the number, type, and power capacity of the pump(s) can be varied to accommodate for different end-user requirements, certain embodiments of the present disclosure contemplate the provision of a centrifugal pump with between approximately 0.25 and 1.5 horsepower. In preferred embodiments, the pump 14 comprises a ½ horsepower centrifugal pump. The pump 14 is operable to convey fluid to a sand separator 30 via a conduit 24. The sand separator 30 is contemplated as comprising a hydrocyclone device that is operable to separate or sort particles in a liquid suspension through the use of centrifugal force. The sand separator 30 removes sand and other solids and particulates from a fluid. An inlet for contaminated fluid and an overflow outlet for cleaned fluid are both provided proximal to an upper end of the sand separator. A lower region of the sand separator 30 comprises an underflow outlet for silt and fluid to be expelled. The sand separator 30 of the depicted system is operable to convey fluid to various different components of the system as will be shown and described herein. A first outlet 36 of the separator 30 comprises a flow restrictor 38 and is in fluid communication with the tank 11. More specifically, the first outlet 36 of the separator provides a limited flow rate of (e.g. between 0.5 and 2.0 gallons/minute) to a second bag filter 42 via a fluid conduit 40. The second bag filter 42 preferably comprises a finer porosity than the first bag filter 34, and the second bag filter 42 is operable to capture and filter oil, silt and sand from a supply of fluid output by the sand separator 30. In preferred embodiments, the second bag filter 42 comprises a porosity of between approximately 25 and 75 microns, and preferably of about 50 microns. In preferred embodiments, both bag filters 34, 42 comprise removable, disposable, and replaceable bag filters.

As shown in FIG. 3 and as will be described in more detail herein, fluid that is passed through the second bag filter 42 is gravity fed to the sloped bottom 16 of the tank 11 and is thereafter subject to further treatment in the system 2. As will be recognized by one of ordinary skill in the art, the sand separator 30 is operable to automatically route fluid to different components of the system based on a contamination level and density of the fluid.

The sand separator 30 of various embodiments comprises a secondary outlet 44 that is operable to convey clean fluid (at least relative to the silt stream provided through the primary outlet 36) to further components of the system 2. The secondary outlet 44 is in communication with first and second cartridge filters 18, 20, and is also operable to convey fluid to an agitator nozzle 46 provided within the tank 11. First and second cartridge filters 18, 20 are provided in parallel. Fluid is provided and filtered through the cartridge filters, which preferably comprise replaceable or washable cartridge-type filters. A two-way valve 48 and a check-valve 50 are provided downstream of the cartridge filters 18, 20. A primary outlet line 52 is provided to convey fluid from the cartridge filters 18, 20 to a recycled fluid tank 56. A secondary outlet line 54 is provided. In some embodiments, the secondary outlet line 54 comprises a valve to selectively dispense or empty fluid from the filters 18, 20 and/or route the fluid to the recycled fluid tank 56 (or other receptacle). In some embodiments, the secondary outlet line 54 provides an outlet and fluid flow path for connecting the system to an additional filtration unit or system via the connection 17 provided on an external surface of the tank 4.

As shown in FIG. 3, a recycled fluid tank 56 and a clean water storage tank 58 are provided in combination with the system 2. The recycled water tank 56 is operable to receive and store fluid cleaned or treated by the system 2 as shown and described herein. The clean water storage tank 58 comprises a source of clean or fresh water (or other fluid). First and second three-way valves 60, 64 and check valves 62, 66 are provided to control fluid flow relative to the recycled fluid tank 56, the clean fluid tank 58, a pressure washing device 68 and the system 2. As shown, fluid may be directed from one or both of the recycled water tank 56 and the clean fluid tank 58 to a pressure washing device where it may be used in cleaning operations (for example). Additionally, fluid may be directed from one or both of the recycled water tank 56 and the clean fluid tank 58 to the tank 11 via a refill line 26 and a float valve 70. The float valve 70 is operable to automatically draw fluid from one or more storage tanks 56, 58 when a fluid level within the tank 11 is below a predetermined level.

The tank 11 of certain embodiments of the present disclosure comprises features for automated liquid refill control. For example, and as shown in FIG. 3, the tank 11 of the depicted system comprises first and second float switches 72, 74. A first float switch 72 is provided as a vacuum float switch that is operable to at least partially control the vacuum motor 32. The first float switch 72 is operable to automatically activate and deactivate the vacuum motor 32 based on a fluid fill level within the tank 11. If the fluid fill level within the tank reaches or exceeds a predetermined fill level corresponding to a sufficient amount of fluid being housed in the tank, the first float switch 72 is operable to deactivate the vacuum motor. Similarly, if the fluid fill level falls below the determined level, the first float switch 72 is operable to activate the vacuum motor 32 to draw fluid into the tank 11. Similarly, and inversely, the second float switch 74 is operable to deactivate the pump 14 when the fluid fill level in the tank falls below a certain level, and is operable to activate the pump 14 when the fluid fill level is at or above a certain level. The float switches 72, 74 and related system components are operable to provide automated water flow regulation to achieve optimized particulate removal. The switches and related functionality are also operable to provide automated liquid level control within a tank to achieve optimized hydraulic performance throughout the system.

Various pressure gauges 51 are provided within the system to monitor operating conditions of the system. Pressure gauges 51 are operable to convey information related to internal pressures within the system 2 and indicate, for example, whether cleaning or replacement of certain components is required. A differential gauge filter monitor 53 is provided to provide information related to a pressure drop or differential on either side of the cartridge filters 18, 20.

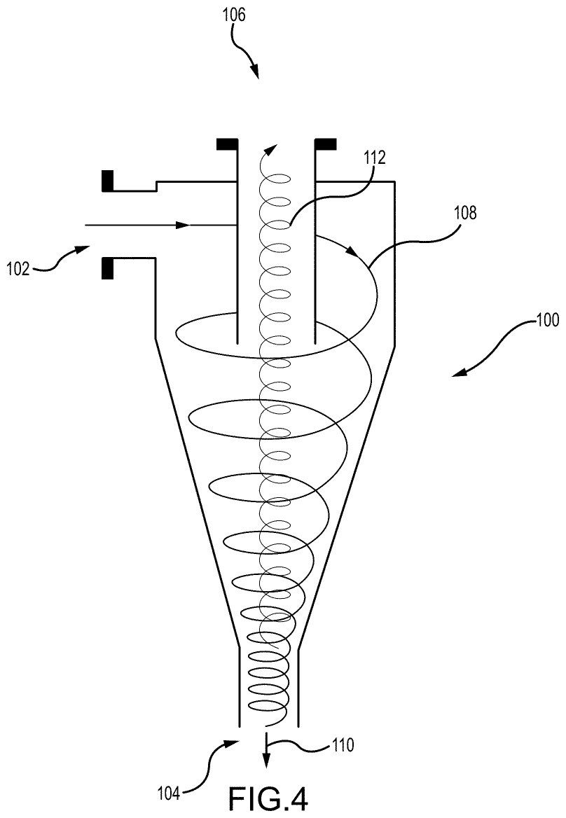

FIG. 4 is a schematic illustration of a filter member for use with various embodiments of the present disclosure. The filter member 100 of FIG. 4 comprises a known, simplified hydrocyclone device for illustration purposes. The filter member 100 is contemplated as receiving fluid to be treated from a pump (14 in FIG. 3, for example). In operation, the filter member 100 receives fluid through an inlet 102. An incoming flow of fluid 108 comprises a quantity of fluid to be treated that is forced and subjected to a cyclonic flow path. The nature of the flow path creates a centrifugal force upon the fluid and solids are thereby separated (at least partially) from the fluid. Coarse solids and denser solutions are separated out and allowed to be gravity-fed through a first outlet 104. Cleaner, less dense fluids 112 are directed upwardly to a secondary outlet 106 at least in part due to their relatively lower density. In this manner, solids and contaminants are mechanically separated from a fluid stream. As shown in FIG. 3, hydrocyclone devices of the present disclosure are operable to automatically segregate fluids into at least two flow paths. A first flow path is provided for contaminants and dirty fluid which are directed back to a bag filter for further processing. A second flow path is provided for fluid that is to be stored and/or reused in pressure washing applications (for example). The second flow path may comprise additional filtering means (cartridge filters 18, 20, for example). In this manner, at least one cyclonic filter element is provided to automatically segregate and route fluid of sufficient cleanliness to a storage tank or cleaning operation, while contaminated fluid is automatically routed to further processing means (e.g. redirected to a bag filter and further treatment in the cyclonic filter). Embodiments of the present disclosure thus provide a means for automatically and continuously treating a fluid until an acceptable level of purity or cleanliness is achieved and without the need for human inspection or interaction with the fluid stream.

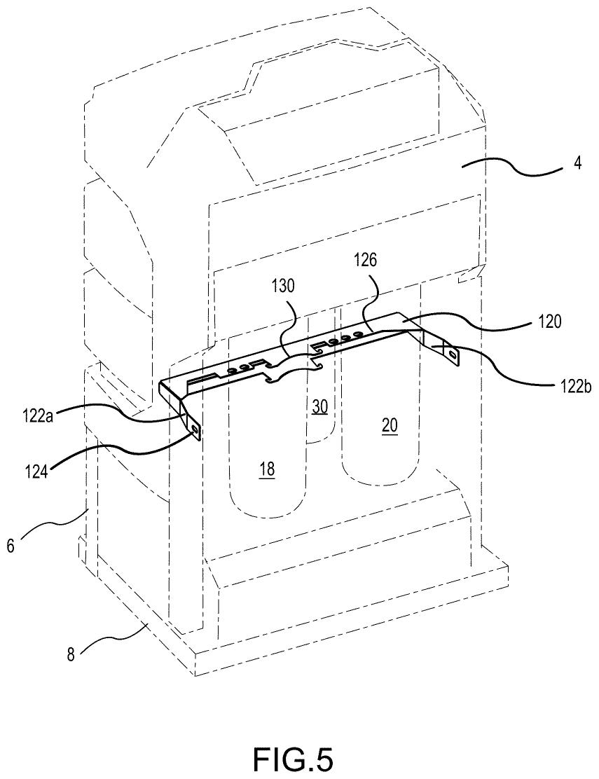

FIG. 5 is a rear perspective view of a fluid collection and filtration system 2 according to one embodiment of the present disclosure. As shown, the system 2 comprises a body 4, a frame 6 and a base member 8. The body 4 is shown in phantom for illustrative purposes. In various embodiments of the present disclosure, at least portions of the body member 4 comprise thin-walled elements to reduce cost and weight and to maximize an internal volume of the body 4. In some embodiments, the body member 4 comprises a thin-walled molded plastic body. While the reduced wall thickness of the body 4 of such embodiments provides various advantages, it also reduces the structural integrity of the walls of the tank in certain respects. Accordingly, embodiments of the present disclosure comprise one or more frame members 6 including a reinforcing rib 120. The reinforcing rib 120 comprises an extension or attachment of the frame 6 and provides structural support to the body 4. The reinforcing rib 120 is operable to resist compressive and tensile forces as the body experiences expansive and compressive forces associated with cyclic vacuum pressures, impact from externalities, internal pressures applied by fluid placed within the body 4, etc.

It is contemplated that one or more reinforcing ribs 120 are provided in certain embodiments of the present disclosure, although only a single reinforcing rib 120 is shown in FIG. 5. In some embodiments, one or more reinforcing ribs are provided that nest or mate within concave portions of the body 4. Ribs of the present disclosure are operable to maintain a structure and shape of the body 4 and serve to increase a lifespan of a body 4 by resisting loadings (e.g. cyclic loads applied by vacuum pressures within the tank) and reducing deflection and strain experienced by the body 4.

FIG. 5 depicts a reinforcing rib 120 of a particular embodiment. It will be recognized, however, that reinforcing ribs 120 of the present disclosure are not limited to the specific rib structure and arrangement as shown in FIG. 5. The rib 120 of FIG. 5 comprises a generally U-shaped element that is either secured to or co-formed with a frame 6 of the system 2. The rib 120 comprises first and second portions 122a, 122b. Each of the first and second portions 122a, 122b of the embodiment of FIG. 5 comprise an aperture or eyelet 124 for receiving a fastener to secure the rib 120 to the frame 6. A lateral member 126 extends between the first and second portions 122a, 122b. In some embodiments, the lateral member 126 is sized and operable to be positioned at least partially with a concave portion of the body 4. In some embodiments a rest or cradle 130 is provided that is operable to receive a sand separator 30, filter, or other component of the system 2.

FIG. 5 depicts a reinforcing rib 120 according to certain embodiments of the present disclosure. It will be recognized, however, that reinforcing ribs of the present disclosure are not limited to the specific arrangement shown in FIG. 5. For example, it is contemplated that one or more reinforcing ribs 120 are provided wherein the rib(s) comprise a U-shaped or partially U-shaped member of various different cross-sectional shapes. A round, ovoid, or rectangular cross-sectional shape is contemplated as being provided, and wherein the rib comprises a plastic or metal element that extends along a portion of the body 4 and supports the body 4. Accordingly, various different ribs, rib structures, and rib shapes are contemplated wherein the rib is provided as a support element that contacts the tank or body 4 of the system.

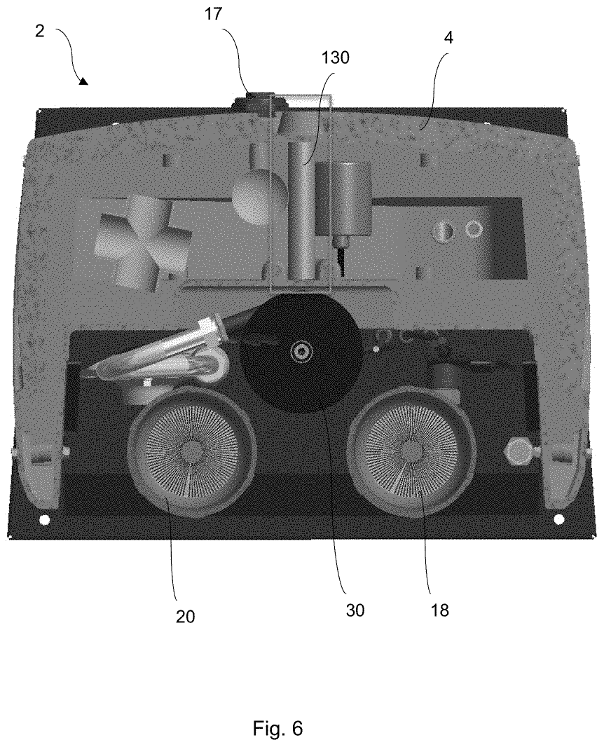

FIG. 6 is a cross-sectional plan view of a system 2 according to one embodiment of the present disclosure. As shown, a body 4 is provided that comprises a thin-walled construction. As discussed, the system comprises at least one vacuum pump and the body 4 is intended to be subjected to various loads including, for example, cyclic loads due to vacuum pressure. Certain embodiments of the present disclosure, including that shown in FIG. 6, comprise an internal support member in the form of a post or column 130 operable to receive and withstand compressive forces and prevent an outer wall 132 of the tank 4 from collapsing due to pressure changes. Although a single column 130 is shown in FIG. 6, it will be recognized that additional columns are contemplated as being inserted within the body 4 to support various portions of the body 4 and prevent or minimize deflection and strain on the body 4. In certain embodiments, columns 130 of the present disclosure are contemplated as comprising a plastic insert such as polyvinyl chloride. First and second cartridge filters 18, 20, a sand separator 30 and a port 17 are provided in FIG. 6 for reference. These features and their operation are shown and described herein and that discussion is incorporated by reference.

The column 130 of FIG. 6 preferably extends between an inner surface of the body 4 and a rigid or partially component of the system (the frame 6, for example). In some embodiments, a plate or flange is provided at one or both ends of the column 130 to distribute a load and reduce pressure on the housing or other components.

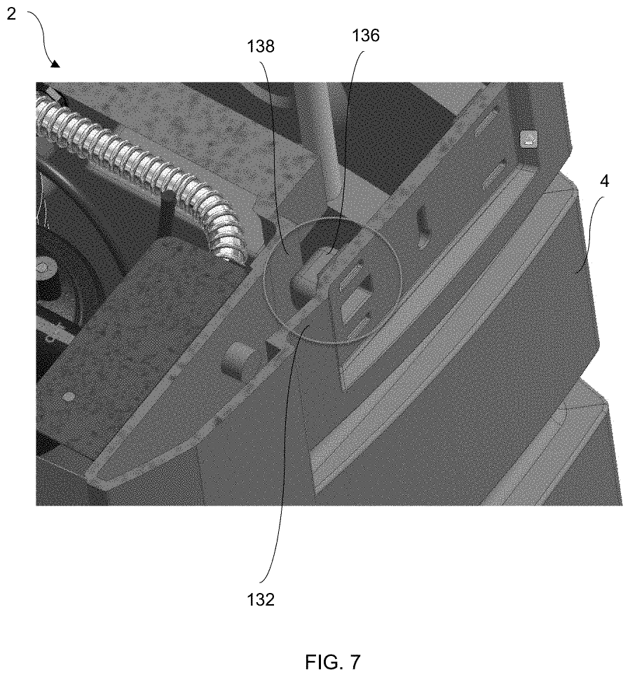

FIG. 7 is a cut-away perspective view of a system 2 according to an embodiment of the present disclosure wherein a body 4 is provided with an internal support member in the form of an inwardly projecting support member 136. As shown, an outer wall 132 of the body 4 comprises a support member 136 that is operable to contact an internal portion of the system at least upon deflection of the outer wall 132. In the embodiment of FIG. 7, the body 4 comprises an outer wall 132 and an inner wall 138 provided in close proximity to the support 136 and the outer wall. The support member 136 is operable to contact the inner wall 138, which is supported by the frame 6. The support member 136 resists movement and deflection of the outer wall 132 at least beyond a certain point. In some embodiments, the support member 136 comprises a molded element that is co-formed with the body 4. In alternative embodiments, however, it is contemplated that the support member 136 is a separate element that is added or attached to the body 4 after formation of the body 4. Although one particular support 136 is shown in FIG. 7, it will be recognized that internal support elements of the present disclosure are not limited to the particular embodiment shown in FIG. 7. Additionally, it is contemplated that a plurality of support elements 136 are provided in certain embodiments. For example, it is contemplated that inwardly-projecting support members 136 are provided at a plurality of locations where deflection or deformation of the body 4 is expected and intended to be minimized.

Although the following text sets forth a detailed description of numerous different embodiments, it should be understood that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity so as to not confuse the reader, and it is not intended that such claim term by limited, by implication or otherwise, to that single meaning.

While various embodiments of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. It is to be expressly understood that such modifications and alterations are within the scope and spirit of the present invention.

What is claimed is:

1. A portable fluid treatment and recycling system comprising:
a fluid tank with a lower portion comprising a sump;
a vacuum pump provided in communication with the fluid tank;
the fluid tank comprising a first filter and a second filter;
a pump that is operable to receive fluid from the fluid tank;
a third filter operable to receive fluid from the pump and remove at least one of sand, silt, sediment, oil, and debris from the fluid;
wherein the third filter comprises a first outlet and a second outlet;
the first outlet provided in fluid communication with the second filter within the fluid tank, and the second outlet provided in fluid communication with the lower portion of the fluid tank and with a fourth filter;
wherein the fourth filter comprises an outlet that is operable to be selectively connected to at least one of a fluid conduit, a storage tank, and a pressure washer.

2. The portable fluid treatment and recycling system of claim 1, wherein the first filter comprises a removable bag filter.

3. The portable fluid treatment and recycling system of claim 1, wherein the second filter comprises a removable bag filter.

4. The portable fluid treatment and recycling system of claim 1, wherein the third filter comprises a hydrocyclone filter.

5. The portable fluid treatment and recycling system of claim 1, wherein the fourth filter comprises a cartridge filter.

6. The portable fluid treatment and recycling system of claim 1, wherein the vacuum pump provides a negative pressure to an internal volume of the fluid tank and the negative pressure is operable to collect fluid from an external source.

7. A portable fluid treatment and recycling system comprising:
a vacuum port;
a fluid tank;
a vacuum pump provided in communication with the fluid tank;
the fluid tank comprising a first filter and a second filter;
a pump that is operable to receive fluid from the fluid tank;
a third filter operable to receive fluid from the pump and remove at least one of sand, silt, sediment, oil, and debris from the fluid;
wherein the third filter comprising a cyclone filter with a first outlet and a second outlet;
wherein suspended solids and liquids comprising a first density are drained through the first outlet of the third filter and liquids of a second density are expelled through the second outlet of the third filter;
the first outlet provided in fluid communication with the second filter within the fluid tank, and the second outlet provided in fluid communication with the lower portion of the fluid tank and with a fourth filter;
wherein the fourth filter comprises an outlet that is operable to be selectively connected to at least one of a fluid conduit, a storage tank, and a pressure washer.

8. The portable fluid treatment and recycling system of claim 7, wherein the first density is greater than the second density.

9. The portable fluid treatment and recycling system of claim 7, wherein the liquids comprising a first density are re-routed through the second filter.

10. The portable fluid treatment and recycling system of claim 7, wherein the second outlet is provided in communication with first and second cartridge filters and a fluid outlet port of the system.

11. A portable fluid treatment and recycling system comprising:
a body supported by a frame;
a fluid storage tank comprising a sump;
a vacuum pump provided in communication with the fluid storage tank;
the fluid storage tank comprising a first filter;
a pump that is operable to receive fluid from the fluid storage tank;
a second filter operable to receive fluid from the pump and remove at least one of sand, silt, sediment, oil, and debris from the fluid;
wherein the second filter comprises a first outlet and a second outlet;
the first outlet provided in fluid communication with the first filter, and the second outlet provided in fluid communication with the lower portion of the fluid tank and with a third filter;
wherein the third filter comprises an outlet that is operable to be selectively connected to at least one of a fluid conduit, a storage tank, and a pressure washer.

12. The portable fluid treatment and recycling system of claim 11, wherein the system comprises an internal support member in communication with the body.

13. The portable fluid treatment and recycling system of claim 12, wherein the internal support member comprises a reinforcing rib extending along at least a portion of the fluid storage tank and wherein the reinforcing rib is operable to withstand force and resist movement when a vacuum pressure is applied to the fluid storage tank.

14. The portable fluid treatment and recycling system of claim 13, wherein the reinforcing rib comprises a horizontally-extending member connected to the frame.

15. The portable fluid treatment and recycling system of claim 13, wherein the reinforcing rib comprises a metal rib.

16. The portable fluid treatment and recycling system of claim 12, wherein the internal support member comprises at least one of a post and a column extending between an inner surface of the fluid tank and a component of the system.

17. The portable fluid treatment and recycling system of claim 12, wherein the internal support member comprises an inwardly-projecting extension.

18. The portable fluid treatment and recycling system of claim 11, wherein the first filter comprises a removable bag filter.

19. The portable fluid treatment and recycling system of claim 11, wherein the second filter comprises a hydrocyclone filter.

20. The portable fluid treatment and recycling system of claim 11, wherein the vacuum pump provides a negative pressure to an internal volume of the fluid storage tank and the negative pressure is operable to collect fluid from an external source.
